(19) United States
(12) Patent Application Publication
(10) Pub. No.: US 2026/0366264 A1
(43) Pub. Date: Nov. 19, 2026

(54) WORK MACHINE

(71) Applicant: KOMATSU LTD., Tokyo (JP)

(72) Inventors: Shota YAMAWAKI, Tokyo (JP); Go SAKUMA, Tokyo (JP)

(21) Appl. No.: 19/136,338

(22) PCT Filed: Dec. 11, 2023
(86) PCT No.: PCT/JP2023/044126

§ 371 Date: Jun. 6, 2025

(30) Foreign Application Priority Data
Dec. 26, 2022 (JP) 2022-207838

(51) Int. Cl. E02F 9/20; E02F 9/22

(52) U.S. Cl. CPC E02F 9/2091; E02F 9/2246; E02F 9/2253

(57) ABSTRACT

A work machine includes a capacitor, a battery connected in parallel to the capacitor, an electric motor, a target portion driven by the electric motor, and a first DC/DC converter. The electric motor is supplied with electric power from the capacitor during a discharge period of the capacitor, and is supplied with electric power from the battery during a discharge period of the battery. The first DC/DC converter switches between discharging and charging of the capacitor during the discharge period of the battery.

### CROSS-REFERENCE TO RELATED APPLICATIONS

This application is a U.S. National stage application of International Application No. PCT/JP2023/044126, filed on Dec. 11, 2023. This U.S. National stage application claims priority under 35 U.S.C. § 119(a) to Japanese Patent Application No. 2022-207838, filed in Japan on Dec. 26, 2022, the entire contents of which are hereby incorporated herein by reference.

### BACKGROUND

### Technical Field

The present disclosure relates to a work machine.

### Background Information

In the technical field related to work machines, a work machine as disclosed in JP 2014-139379 A is known.

### SUMMARY

Generally, as the capacity density of a battery is higher, the power density of the battery is lower. The capacity density of a battery refers to electrical energy that can be stored in the battery per unit volume or per unit mass. The power density of a battery refers to electrical energy that the battery can output per unit volume or per unit mass. When the work machine operates based on the electric power output from the battery, as the capacity density of the battery is higher, the work machine can operate for a longer time. As the power density of the battery is higher, the work machine can perform more instantaneous higher-power operation.

When the work machine operates based on the electric power output from the battery, if the battery is selected in accordance with the electric power required for the instantaneous high-power operation, there is a possibility that an excessively large battery is mounted on the work machine. When the load factor of the battery increases due to the instantaneous high-power operation, deterioration of the battery may be accelerated. Although the power density of a capacitor is higher than the power density of the battery, the capacity density of the capacitor is lower than the capacity density of the battery. Therefore, it is difficult to operate the work machine for a long time only with electrical energy output from the capacitor.

It is an object of the present disclosure to suppress an increase in size of a battery and deterioration of the battery when a work machine is operated based on electric power output from the battery.

According to the present disclosure, a work machine is provided, the work machine including: a capacitor; a battery connected in parallel to the capacitor; an electric motor supplied with electric power from the capacitor during a discharge period of the capacitor, and supplied with electric power from the battery during a discharge period of the battery; a target portion driven by the electric motor; and a first DC/DC converter configured to switch between discharging and charging of the capacitor during the discharge period of the battery.

According to the present disclosure, when a work machine is operated based on electric power output from a battery, an increase in the size of the battery and deterioration of the battery are suppressed.

### BRIEF DESCRIPTION OF DRAWINGS

FIG. 1 is a perspective view illustrating a work machine according to an embodiment.

FIG. 2 is a diagram illustrating a drive system of the work machine according to the embodiment.

FIG. 3 is a block diagram illustrating the work machine according to the embodiment.

FIG. 4 is a diagram for explaining a method for driving the drive system according to the embodiment.

FIG. 5 is a diagram illustrating a relationship between an operational state of an operation device according to the embodiment and a capacitor.

### DETAILED DESCRIPTION OF EMBODIMENT(S)

Hereinafter, embodiments of the disclosure will be described with reference to the drawings, but the disclosure is not limited to the embodiments. Components of the embodiments described below can be combined as appropriate. In addition, some components may not be used in some cases.

### Work Machine

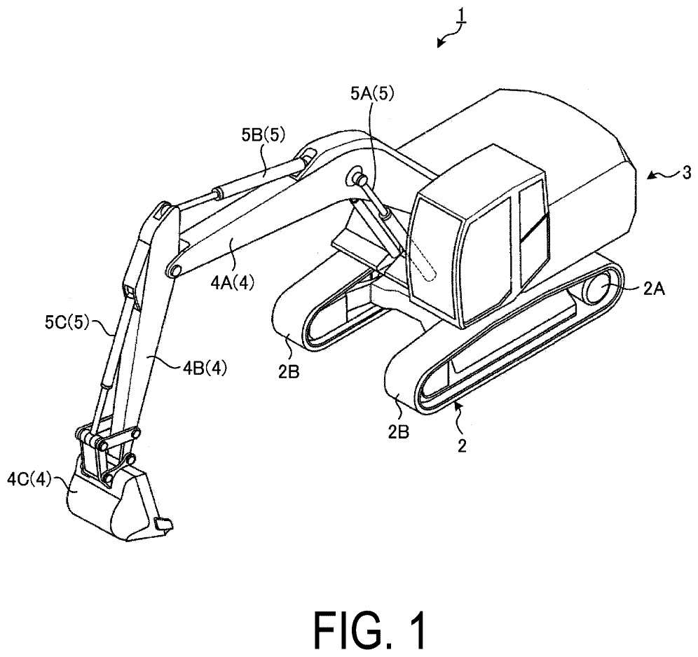

FIG. 1 is a perspective view illustrating a work machine 1 according to the embodiment. In the embodiment, the work machine 1 is a hydraulic excavator, which is a type of construction machine. As illustrated in FIG. 1, the work machine 1 includes a traveling body 2, a revolving body 3 supported by the traveling body 2, a work implement 4 supported by the revolving body 3, and a work implement cylinder 5 that operates the work implement 4.

The traveling body 2 includes a drive wheel 2A and a crawler belt 2B rotated by the drive wheel 2A. The rotation of the crawler belt 2B allows the work machine 1 to travel on a work site. The revolving body 3 revolves while being supported by the traveling body 2. The work implement 4 includes a boom 4A connected to the revolving body 3, an arm 4B connected to the boom 4A, and a bucket 4C connected to the arm 4B. The work implement cylinder 5 is a hydraulic cylinder that generates power for operating the work implement 4. The work implement cylinder 5 includes a boom cylinder 5A that operates the boom 4A, an arm cylinder 5B that operates the arm 4B, and a bucket cylinder 5C that operates the bucket 4C.

### Drive System

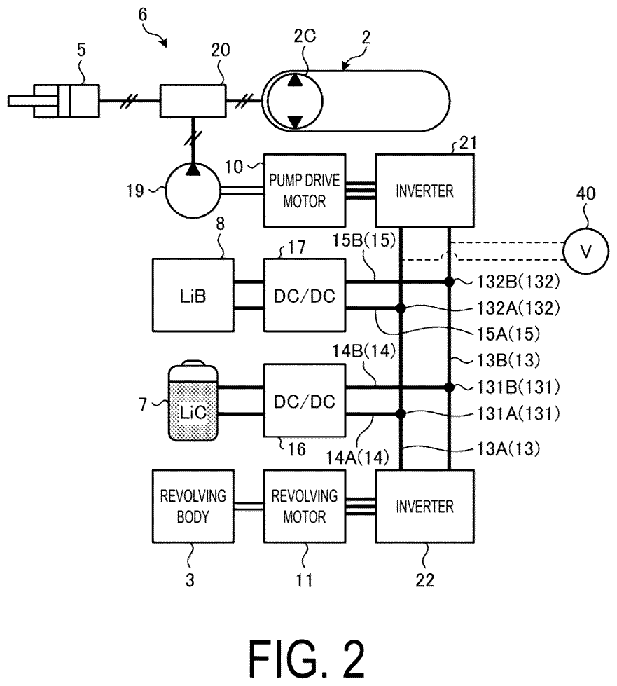

FIG. 2 is a diagram illustrating a drive system 6 of the work machine 1 according to the embodiment. The drive system 6 includes a capacitor 7, a battery 8 connected in parallel to the capacitor 7, and a pump drive motor 10 and a revolving motor 11 to which electric power is supplied from the capacitor 7 during a discharge period of the capacitor 7 and from the battery 8 during a discharge period of the battery 8. Each of the pump drive motor 10 and the revolving motor 11 is an electric motor. The capacitor 7 is a lithium ion capacitor (LiC). The battery 8 is a lithium ion battery (LiB).

The drive system 6 also includes a power line 13 connected to each of the pump drive motor 10 and the revolving motor 11, a first connection line 14 connecting the capacitor 7 and a first portion 131 of the power line 13, a second connection line 15 connecting the battery 8 and a second portion 132 of the power line 13, a DC/DC converter 16 (first DC/DC converter) connected to the capacitor 7, and a DC/DC converter 17 (second DC/DC converter) connected to battery 8.

The pump drive motor 10 is actuated based on at least electric power supplied from the battery 8. During a discharge period of the battery 8, which indicates a period during which the battery 8 is discharged, the pump drive motor 10 is supplied with electric power from the battery 8. During a discharge period of the capacitor 7, which indicates a period during which the capacitor 7 is discharged, the pump drive motor 10 is supplied with electric power from the capacitor 7. The drive system 6 includes a hydraulic pump 19. The pump drive motor 10 generates power for actuating the hydraulic pump 19. The hydraulic pump 19 is actuated by the pump drive motor 10 which is an electric motor. The hydraulic pump 19 is an example of a target portion of the work machine 1, which is driven by the electric motor.

The hydraulic pump 19 discharges hydraulic oil to be supplied to the work implement cylinder 5. The hydraulic pump 19 discharges hydraulic oil to be supplied to a traveling motor 2C of the traveling body 2. The hydraulic oil discharged from the hydraulic pump 19 is supplied to each of the work implement cylinder 5 and the traveling motor 2C via a control valve 20. When the hydraulic oil is supplied to the work implement cylinder 5, the work implement cylinder 5 is actuated. When the hydraulic oil is supplied to the traveling motor 2C, the traveling motor 2C is actuated. The traveling motor 2C is a hydraulic motor that rotates the drive wheel 2A of the traveling body 2.

The revolving motor 11 is actuated based on at least electric power supplied from the battery 8. During the discharge period of the battery 8, the revolving motor 11 is supplied with electric power from the battery 8. During the discharge period of the capacitor 7, the revolving motor 11 is supplied with electric power from the capacitor 7. The revolving motor 11 generates power for revolving the revolving body 3. The revolving body 3 is revolved by the revolving motor 11 which is an electric motor. The revolving body 3 is an example of a target portion of the work machine 1, which is driven by the electric motor.

The power line 13 is connected to each of the pump drive motor 10 and the revolving motor 11. The capacitor 7 and the battery 8 are connected in parallel to each other to the power line 13. The power line 13 includes a positive electrode line 13A and a negative electrode line 13B. A part of the power line 13 is connected to the pump drive motor 10 via an inverter 21. Another part of the power line 13 is connected to the revolving motor 11 via an inverter 22.

The first connection line 14 connects the capacitor 7 and the first portion 131 of the power line 13. The first connection line 14 includes a positive electrode line 14A and a negative electrode line 14B. The positive electrode line 14A connects a positive electrode of the capacitor 7 and a first portion 131A of the positive electrode line 13A. The negative electrode line 14B connects a negative electrode of the capacitor 7 and a first portion 131B of the negative electrode line 13B.

The second connection line 15 connects the battery 8 and the second portion 132 of the power line 13. The second connection line 15 includes a positive electrode line 15A and a negative electrode line 15B. The positive electrode line 15A connects a positive electrode of the battery 8 and a second portion 132A of the positive electrode line 13A. The negative electrode line 15B connects a negative electrode of the battery 8 and a second portion 132B of the negative electrode line 13B.

The capacitor 7 can supply electric power to each of the pump drive motor 10 and the revolving motor 11 via the first connection line 14 and the power line 13. The battery 8 supplies electric power to each of the pump drive motor 10 and the revolving motor 11 via the second connection line 15 and the power line 13.

The DC/DC converter 16 is connected to the capacitor 7. The DC/DC converter 16 is disposed on the first connection line 14 between the capacitor 7 and the first portion 131 of the power line 13. Electric power from the capacitor 7 is supplied to each of the pump drive motor 10 and the revolving motor 11 via the DC/DC converter 16. The DC/DC converter 16 converts the voltage of capacitor 7. The DC/DC converter 16 boosts the voltage of the capacitor 7 at a predetermined boost ratio. The voltage of the capacitor 7 boosted by the DC/DC converter 16 is applied to the inverter 21 connected to the pump drive motor 10, and to the inverter 22 connected to the revolving motor 11.

The DC/DC converter 16 is a bidirectional DC/DC converter capable of outputting electric power from the primary side to the secondary side and capable of outputting electric power from the secondary side to the primary side. The primary side of the DC/DC converter 16 is a low voltage side (capacitor 7 side). The secondary side of the DC/DC converter 16 is a high voltage side (power line 13 side). The DC/DC converter 16 steps down the regenerative voltage of the revolving motor 11 at a predetermined step-down ratio. The regenerative voltage of the revolving motor 11 stepped down by the DC/DC converter 16 is applied to the capacitor 7. The capacitor 7 is charged with the regenerative voltage of the revolving motor 11. The capacitor 7 is charged with regenerative electric power supplied from the revolving motor 11 via the DC/DC converter 16.

The DC/DC converter 17 is connected to the battery 8. The DC/DC converter 17 is disposed on the second connection line 15 between the battery 8 and the second portion 132 of the power line 13. Electric power from the battery 8 is supplied to each of the pump drive motor 10 and the revolving motor 11 via the DC/DC converter 17. The DC/DC converter 17 converts the voltage of the battery 8. The DC/DC converter 17 boosts the voltage of the battery 8 at a predetermined boost ratio. The voltage of the battery 8 boosted by the DC/DC converter 17 is applied to the inverter 21 connected to the pump drive motor 10, and to the inverter 22 connected to the revolving motor 11.

The DC/DC converter 17 is a unidirectional DC/DC converter capable of outputting electric power only from the primary side to the secondary side. The primary side of the DC/DC converter 17 is a low voltage side (battery 8 side). The secondary side of the DC/DC converter 17 is a high voltage side (power line 13 side). The capacitor 7 is charged with the voltage of the battery 8. The capacitor 7 is charged with electric power supplied from the battery 8 via the DC/DC converter 17 and the DC/DC converter 16. Note that the DC/DC converter 17 may be a bidirectional DC/DC converter capable of outputting electric power from the primary side to the secondary side, and capable of outputting electric power from the secondary side to the primary side.

The inverter 21 is connected to a part of the power line 13. The inverter 21 converts a direct current from the power line 13 into a three-phase alternating current and supplies this current to the pump drive motor 10. The pump drive motor 10 is driven based on the three-phase alternating current supplied from the inverter 21.

The inverter 22 is connected to a part of the power line 13. The inverter 22 converts a direct current from the power line 13 into a three-phase alternating current and supplies this current to the revolving motor 11. The revolving motor 11 is driven based on the three-phase alternating current supplied from the inverter 22.

A power density of the capacitor 7 is higher than a power density of the battery 8. The capacitor 7 is superior in responsiveness to the battery 8. The capacitor 7 can be charged and discharged faster than the battery 8. A capacity density of the battery 8 is higher than a capacity density of the capacitor 7.

The battery 8 is a main power source of the drive system 6. The battery 8 supplies electric power to each of the pump drive motor 10 and the revolving motor 11. Each of the pump drive motor 10 and the revolving motor 11 is driven exclusively by the electric power supplied from the battery 8. Most of the electric power for driving each of the pump drive motor 10 and the revolving motor 11 is provided from electric power output from the battery 8. The electric power output from the capacitor 7 is used when instantaneous responsiveness of each of the pump drive motor 10 and the revolving motor 11 is required.

### Controller

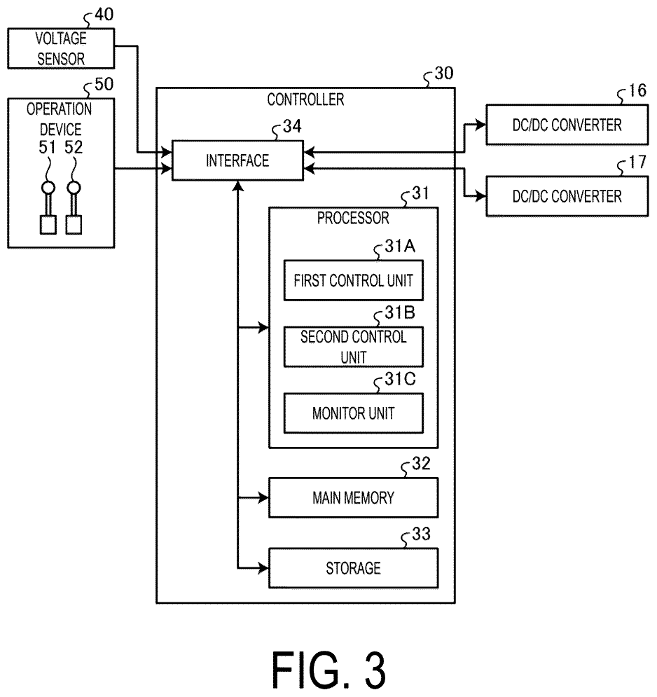

FIG. 3 is a block diagram illustrating the work machine 1 according to the embodiment. The work machine 1 includes a controller 30, a voltage sensor 40, and an operation device 50.

The controller 30 includes a computer system. The controller 30 includes a processor 31 such as a central processing unit (CPU), a main memory 32 including a non-volatile memory such as a read only memory (ROM) and a volatile memory such as a random access memory (RAM), a storage 33, and an interface 34 including an input-output circuit. Each of the voltage sensor 40, the operation device 50, the DC/DC converter 16, and the DC/DC converter 17 is connected to the interface 34.

The voltage sensor 40 detects a voltage applied to each of the pump drive motor 10 and the revolving motor 11. As illustrated in FIG. 2, the voltage sensor 40 detects a voltage between the positive electrode line 13A and the negative electrode line 13B.

The operation device 50 is operated by an operator of the work machine 1 in order to operate the revolving body 3 and the work implement 4. The operation device 50 is disposed in a cab of the work machine 1. The operation device 50 includes a left operation lever 51 and a right operation lever 52. As an example, when the left operation lever 51 is operated to be tilted forward, the revolving body 3 swings to the right, and when the left operation lever 51 is operated to be tilted rearward, the revolving body 3 swings to the left. When the left operation lever 51 is operated to be tilted leftward, the arm 4B performs a dumping operation. When the left operation lever 51 is operated to be tilted rightward, the arm 4B performs an excavating operation. When the right operation lever 52 is operated to be tilted forward, the boom 4A performs a lowering operation. When the right operation lever 52 is operated to be tilted rearward, the boom 4A performs a raising operation. When the right operation lever 52 is operated to be tilted leftward, the bucket 4C performs an excavating operation. When the right operation lever 52 is operated to be tilted rightward, the bucket 4C performs a dumping operation.

The processor 31 includes a first control unit 31A, a second control unit 31B, and a monitor unit 31C. The first control unit 31 A outputs a control command for controlling the DC/DC converter 16. The second control unit 31B outputs a control command for controlling the DC/DC converter 17. The monitor unit 31C can monitor the load factor of the electric motor (the pump drive motor 10 and the revolving motor 11). The load factor of the electric motor refers to a ratio of an actual output to a rated output (designed 100% output) of the electric motor. The monitor unit 31C can monitor the load factor of the pump drive motor 10 based on the actuation state of the inverter 21. The monitor unit 31C can monitor the load factor of the revolving motor 11 based on the actuation state of the inverter 22. The monitor unit 31C monitors a detection value of the voltage sensor 40. The monitor unit 31C monitors the operational state of the operation device 50. When the operation device 50 is operated, an operation signal is generated. The monitor unit 31C can monitor the operational state of the operation device 50 based on the operation signal generated in the operation device 50.

### Driving Method of Drive System

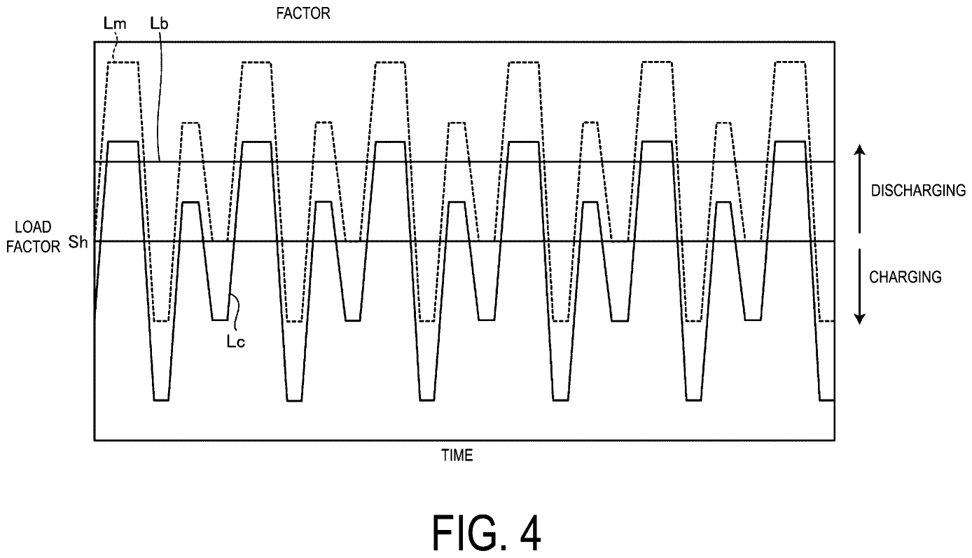

FIG. 4 is a diagram for explaining a method for driving the drive system 6 according to the embodiment. In the graph shown in FIG. 4, the vertical axis indicates the load factor, and the horizontal axis indicates the time having elapsed since the start of work by the work machine 1. A line Lm indicates the load factor of the electric motor (the pump drive motor 10 and the revolving motor 11). A line Lb indicates the load factor of the battery 8. A line Lc indicates the load factor of the capacitor 7. The load factor of the electric motor corresponds to the electric power consumed by the electric motor on a one-to-one basis. The load factor of the battery 8 corresponds to the electric power discharged from the battery 8 on a one-to-one basis. The load factor of the capacitor 7 corresponds to the power discharged from the capacitor 7 on a one-to-one basis.

The load factor of the electric motor varies based on the operation of the work machine 1. When the work machine 1 performs an operation with a heavy workload, the load factor of the electric motor increases. When the work machine 1 performs an operation with a light workload, the load factor of the electric motor decreases. For example, when the boom 4A performs a raising operation in a state in which excavated material is held in the bucket 4C, the work implement 4 is under a heavy load, and thus the load factor of the pump drive motor 10 increases. When the revolving body 3 revolves, the load factor of the revolving motor 11 increases. When the work implement 4 is not operated, the load factor of the pump drive motor 10 decreases. When the revolving body 3 is not revolved, the load factor of the revolving motor 11 decreases.

As described above, the battery 8 is the main power source of the drive system 6. During an operation period in which at least a part of the work machine 1 is in operation, the battery 8 continues to discharge. That is, during the operation period of the work machine 1, the battery 8 continues to supply electric power to each of the pump drive motor 10 and the revolving motor 11. The operation period of the work machine 1 coincides with the discharge period of the battery 8. In the embodiment, as indicated by the line Lb, during the discharge period of the battery 8, the battery 8 discharges at a constant power. The second control unit 31B controls the DC/DC converter 17 so that the battery 8 discharges at a constant power. The DC/DC converter 17 discharges the battery 8 at a constant power during the discharge period of the battery 8.

Note that the operation period of the work machine 1 and the discharge period of the battery 8 may not coincide with each other. The electric power discharged from the battery 8 may not be constant during the discharge time of the battery 8.

The first control unit 31A controls the DC/DC converter 16 so that the capacitor 7 switches between discharging and charging during the discharge period of the battery 8. The DC/DC converter 16 switches between discharging and charging of the capacitor 7 during the discharge period of the battery 8.

The first control unit 31A controls the DC/DC converter 16 such that the capacitor 7 switches between discharging and charging based on the load factor of the electric motor monitored by the monitor unit 31C and the electric power discharged from the battery 8. When the load factor of the electric motor is equal to or greater than a predetermined load factor threshold Sh, the first control unit 31 A controls the DC/DC converter 16 so that the capacitor 7 discharges based on the electric power discharged from the battery 8. That is, when the work machine 1 has a heavy workload, and the load factor of the electric motor is high, the DC/DC converter 16 discharges the capacitor 7 to supplement the electric power discharged from the battery 8. When the load factor of the electric motor is high, electric power is supplied to the electric motor from both the battery 8 and the capacitor 7, and thus shortage of electric power for the electric motor is suppressed.

The first control unit 31A controls the DC/DC converter 16 so that the capacitor 7 is charged based on the electric power discharged from the battery 8 when the load factor of the electric motor is less than the load factor threshold Sh. That is, when the work machine 1 has a light workload, and the load factor of the electric motor is low, the work machine 1 has the discharged electric power left from the battery 8. The first control unit 31A controls the DC/DC converter 16 such that the capacitor 7 is charged with electric power discharged from the battery 8. The DC/DC converter 16 charges the capacitor 7 with surplus power from the battery 8.

Note that the DC/DC converter 16 may switch between discharging and charging of the capacitor 7 based on the detection value of the voltage sensor 40. When the load factor of the electric motor is high, the detection value of the voltage sensor 40 decreases. When the load factor of the electric motor is low, the detection value of the voltage sensor 40 increases. When the detection value of the voltage sensor 40 is a predetermined voltage threshold or less, the DC/DC converter 16 discharges the capacitor 7. The electric power discharged from the capacitor 7 is supplied to the electric motor together with the electric power discharged from the battery 8. When the detection value of the voltage sensor 40 exceeds the voltage threshold, the DC/DC converter 16 charges the capacitor 7 with the surplus power from the battery 8.

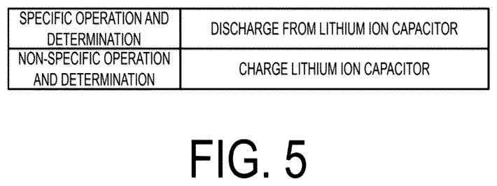

FIG. 5 is a diagram illustrating a relationship between an operational state of the operation device 50 according to the embodiment and the capacitor 7. As illustrated in FIG. 5, the DC/DC converter 16 may switch between discharging and charging of the capacitor 7 based on the operational state of the operation device 50. The DC/DC converter 16 discharges the capacitor 7 when the operation device 50 is operated so that the revolving body 3 and the work implement 4 perform a predetermined specific operation. The DC/DC converter 16 charges the capacitor 7 when the operation device 50 is operated so that the revolving body 3 and the work implement 4 perform a non-specific operation different from the specific operation. The specific operation is an operation of the work machine 1 having a heavy workload. The non-specific operation is an operation of the work machine 1 having a light workload. Examples of the specific operation include an operation in which the revolving body 3 revolves while the boom 4A performs the raising operation. Examples of the non-specific operation include an operation in which the revolving body 3 stops or revolves at a low speed with the work implement 4 stopping.

As described above, in the embodiment, the work machine 1 includes the capacitor 7, the battery 8 connected in parallel to the capacitor 7, the electric motor (the pump drive motor 10 and the revolving motor 11) supplied with electric power from the capacitor 7 during the discharge period of the capacitor 7, and supplied with electric power from the battery 8 during the discharge period of the battery 8, the target portion driven by the electric motor, and the DC/DC converter 16 that switches between discharging and charging of the capacitor 7 during the discharge period of the battery 8.

A capacity density of the battery 8 is higher than a capacity density of the capacitor 7. Therefore, by continuing the discharging of the battery 8, the work machine 1 can operate for a long time. A power density of the capacitor 7 is higher than a power density of the battery 8. The capacitor 7 is superior in responsiveness to the battery 8. The capacitor 7 can be charged and discharged faster than the battery 8. Therefore, in the discharge period of the battery 8, when the work machine 1 instantaneously performs a high-output operation, the capacitor 7 discharges in accordance with the instantaneous high-output operation of the work machine 1, so that electric power shortage in the electric motor is suppressed in a state where an increase in the load factor of the battery 8 is suppressed. Since an increase in the load factor of the battery 8 is suppressed, deterioration of the battery 8 is suppressed. When the work machine 1 performs an instantaneous high-output operation, the electric power discharged from the battery 8 is supplemented with the electric power discharged from the capacitor 7, so that it is not necessary to mount an excessively large battery 8 on the work machine 1. Therefore, an increase in the size of the battery 8 is suppressed.

### Other Embodiments

In the above-described embodiment, the work machine 1 is a hydraulic excavator. The work machine 1 may be a bulldozer having a work implement, or a wheel loader having a work implement. The work machine 1 may be a dump truck which is a type of transport vehicle. In a dump truck, a battery is charged with regenerative electric power from a traveling motor when the dump truck descends a slope.

1. A work machine comprising:
a capacitor;
a battery connected in parallel to the capacitor;
an electric motor
supplied with electric power from the capacitor during a discharge period of the capacitor, and
supplied with electric power from the battery during a discharge period of the battery;
a target portion driven by the electric motor; and
a first DC/DC converter configured to switch between discharging and charging of the capacitor during the discharge period of the battery.

2. The work machine according to claim 1, wherein
the first DC/DC converter switches between discharging and charging of the capacitor based on a load factor of the electric motor and electric power discharged from the battery.

3. The work machine according to claim 2, wherein
the first DC/DC converter
discharges the capacitor based on the electric power discharged from the battery when the load factor of the electric motor is equal to or greater than a load factor threshold, and
charges the capacitor based on the electric power discharged from the battery when the load factor of the electric motor is less than the load factor threshold.

4. The work machine according to claim 1, further comprising:
a voltage sensor configured to detect a voltage applied to the electric motor,
the first DC/DC converter switching between discharging and charging of the capacitor based on a detection value of the voltage sensor.

5. The work machine according to claim 4, wherein
the first DC/DC converter
discharges the capacitor when the detection value of the voltage sensor is equal to or less than a voltage threshold, and
charges the capacitor when the detection value of the voltage sensor exceeds the voltage threshold.

6. The work machine according to claim 1, further comprising:
a revolving body;
a work implement supported by the revolving body;
a work implement cylinder configured to operate the work implement; and
a hydraulic pump configured to discharge hydraulic oil to be supplied to the work implement cylinder,
the target portion including at least one of the revolving body revolved by the electric motor and the hydraulic pump actuated by the electric motor,
the work machine further comprising an operation device operated to operate the revolving body and the work implement, and
the first DC/DC converter switching between discharging and charging of the capacitor based on an operational state of the operation device.

7. The work machine according to claim 6, wherein
the first DC/DC converter
discharges the capacitor when the operation device is operated in such a manner that the revolving body and the work implement perform a predetermined specific operation, and
charges the capacitor when the operation device is operated in such a manner that the revolving body and the work implement perform a non-specific operation different from the specific operation.

8. The work machine according to claim 1, wherein
the capacitor is charged with at least one of electric power from the battery and regenerative electric power from the electric motor.

9. The work machine according to claim 1, further comprising:
a power line connected to the electric motor; and
a first connection line connecting the capacitor and a first portion of the power line,
the first DC/DC converter being disposed on the first connection line.

10. The work machine according to claim 1, wherein
the battery discharges at a constant power during the discharge period of the battery.

11. The work machine according to claim 10, further comprising:
a second DC/DC converter configured to discharge the battery at the constant power during the discharge period of the battery.

12. The work machine according to claim 11, further comprising:
a power line connected to the electric motor; and
a second connection line connecting the battery and a second portion of the power line,
the second DC/DC converter being disposed on the second connection line.

13. The work machine according to claim 1, further comprising:
a hydraulic pump, the target portion including the hydraulic pump actuated by the electric motor.

14. The work machine according to claim 13, further comprising:
a work implement; and
a work implement cylinder configured to operate the work implement,
the hydraulic pump discharging hydraulic oil to be supplied to the work implement cylinder.

15. The work machine according to claim 13, further comprising:
a traveling body including a drive wheel; and
a traveling motor configured to rotate the drive wheel,
the hydraulic pump discharging hydraulic oil to be supplied to the traveling motor.

16. The work machine according to claim 1, further comprising:
a traveling body; and
a revolving body supported by the traveling body,
the target portion including the revolving body revolved by the electric motor.

17. The work machine according to claim 16, wherein
the capacitor is charged with a regenerative voltage of the electric motor configured to revolve the revolving body.

18. The work machine according to claim 1, wherein
the capacitor is a lithium ion capacitor, and
the battery is a lithium ion battery.
